(19) United States
(12) Patent Application Publication
(10) Pub. No.: US 2015/0339695 A1
(43) Pub. Date: Nov. 26, 2015

(54) COMPUTER-IMPLEMENTED SYSTEM AND METHOD FOR INCENTIVIZING CUSTOMERS PROPORTIONATE TO SOCIAL MEDIA SHARING

(71) Applicant: Alexei Fomine, Houston, TX (US)

(72) Inventor: Alexei Fomine, Houston, TX (US)

(21) Appl. No.: 14/283,247

(22) Filed: May 21, 2014

(51) Int. Cl. G06Q 30/02; H04L 29/08

(52) U.S. Cl. CPC G06Q 30/0217; H04L 67/10

(57) ABSTRACT

Disclosed is a computer-implemented incentivizing system for providing a shopping incentive to a primary user in exchange for sharing sharable information on a computer-based host system with one or more secondary users on a social networking platform where the primary user holds a membership account. A secondary user comprises a fellow user of the primary user on the social networking platform the personal profile of whom is associated with that of the primary user. The shopping incentive provided to the primary user is proportionate to the number of applicable users the sharable information is shared with wherein, an applicable user comprises a secondary user that satisfies a predefined condition set by host system. The incentivizing system comprises a criteria module for determining the number of applicable users associated with the primary user on the social networking platform, a post module for disseminating the sharable information to at least the applicable users, and an incentive module for generating the shopping incentive for the primary user based on number of applicable users determined by the criteria module.

### BACKGROUND

1. Field of the Invention

The present invention relates to various computer-implemented systems and methods for generating shopping incentives and more particularly, to a computer-implemented system and method that generates shopping incentives to customers in exchange for and in proportion to sharing of (or posting) promotional information on social media including electronic networks such as, professional and non-professional social networks, discussion boards, even online multi-player gaming sites, etc., essentially wherever interaction between people is facilitated.

The immense popularity and usage of the Internet for communication and interaction has led to the proliferation of various forms of advertising to such an extent that it is now seen as intrusive, redundant, and extremely bothersome by an average internet user. For instance, no matter how innovatively a product (or service) is pitched to a user (by way of an advertisement) on social media, it is stigmatized as ‘spam’ by the user, thus not even warranting it a glance.

But, that is not even the root of the problem. If one looks closer, it will come amply clear that it is not the content but the source of the content that makes the user decide whether or not to grant it an audience. Therefore, if content is received from a source that the user is not familiar with, then there is generally very little probability for it to be even looked at. Corroborating this statement is a finding unearthed by recent online marketing studies that a large portion of online purchases will not be completed unless referred or recommended by friends.

Therefore, in the light of is what is discussed, there is a need in the art for a solution for the aforementioned problem.

### SUMMARY

The present invention comprises a computer-implemented incentivizing system that, in exchange for offering shopping incentives, enables retailers to advertise by having users “share” commercial promotional content with his/her “friends” on social media including electronic networks such as, professional and non-professional social networks, such as Facebook™, LinkedIn™, Twitter™, Myspace™, etc. Further, the incentivizing system awards the customers incentives in proportion to the number of “applicable friends”, the promotional content has been shared with wherein, an “applicable friend” comprises a “friend”, “connection”, or the like, that satisfies a predefined condition. In one example, an applicable friend could be a “friend” that lives within a particular geographical location. In another example, an applicable friend could be a “friend” that pertains to a particular age group. In yet another example, an applicable friend could be a “friend” that lives within a particular geographical location and that pertains to a particular age group.

In one embodiment, the incentivizing system, upon receiving consent from a customer to “promote” a product, service, etc., receives the login details of the customer for a social networking platform where he/she has a membership account. The incentivizing system comprises a criteria module that, from the parsing of the personal profile of the user on his/her social networking platform, determines the number of “applicable friends” the user has as the promotional content is posted on all the “friends” personal accounts on behalf of the user. The incentivizing system further comprises an incentive module that calculates the incentive (such as, a discount, cashback, etc.) based on the number of “applicable friends” as determined by the criteria module. The incentive, thereafter, is awarded to the customer.

For example, a retailer offers a discount to any customer who is willing to share promotional information on his/her social networking platform with at least 100 “friends” who live within a 50 miles radius of the retailer's location. Upon receiving consent from a customer to “promote” a product, etc., the incentivizing system uses customer's login details to access his/her social networking platform to calculate if that customer has in fact at least 100 “friends” who live within 50 miles radius. If the predefined criteria are met, the promotional content is posted on the “friends' communication wall”, or the like, on behalf of the customer and the discount is awarded to the customer proportionately. When needed, the incentivizing system is able to calculate incentives based on any number of predetermined factors, such as, the number of “friends” and their physical locations, demographics, religious beliefs, marital status, age, hobbies, etc.

The present invention thus provides an effective opportunity to sellers to reach out to social media users delivering advertisements for products (and services) purchased and endorsed by “friends” and similar familiar and trusted sources.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, depicts a schematic block diagram of the computer-implemented incentivizing system and the relationship thereof shared with various other entities.

FIGS. 2A through 2D, according to an embodiment of the present invention, are exemplary sequential screenshots of a webpage displaying the sharable information along with a “share” hyperlink, a webpage displaying the template information, a webpage displaying login fields upon the selection of the “share” hyperlink, and a webpage displaying a discount earned.

FIG. 3, according to an embodiment of the present invention, depicts a flowchart depicting the process flow of the computer-implemented incentivizing method.

### FIGURES—REFERENCE NUMERALS

10—computer-implemented incentivizing system

12—computer-based host system

14—User Interface

16—Communications Network

18—Database

20—Processor

22—Remote User Terminal

24—Sharing Initiator

26—Exemplary Sharable Information

28—Exemplary Sharing Hyperlink

29—Social Networking Platform

30—Login Field

32—Criteria Module

34—Template Module

36—Post Module

38—Incentive Module

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Embodiments of the present invention are directed to a computer-implemented system and method (hereinafter referred to as the “incentivizing system and method”) for incentivizing a customer (hereinafter referred to as the “primary user”) in exchange for sharing sharable information with secondary users on a social networking platform, where the primary user holds a membership account. The social networking platform may comprise a professional network, such as LinkedIn™, or a non-professional network such as Facebook™, Twitter™, etc. In one embodiment, the social networking platform may comprise a discussion board, or even an online multiplayer platform. Essentially, the social networking platform may comprise any electronic network that supports and facilitates people interaction. “incentivizing” includes providing a shopping discount, a cashback, a freebie, etc. Further, the incentivizing system and method are configured such that, the magnitude of the incentive provided is proportionate to the number of applicable users the sharable information is shared with wherein, the applicable users comprise a subset of the secondary users that satisfy a predefined criteria or the entirety of the secondary users in the absence of the predefined criteria.

The sharable information is disposed on, pertains to, and is shared from a computer-based host system (hereinafter referred to as the “host system”), which comprises an online entity ‘fronted’ by a website, a mobile application, or the like, accessed via a communications network, such as, the Internet. The host system may, for example, comprise an online news channel, a shopping website, a job portal, etc. The sharable information may comprise promotional information pertaining to an online store, information reflecting a purchase activity of the primary user on an online store, etc. Further, the sharable information could be in the form of a text or multimedia content such as an audio or a video clip. A secondary user comprises a user of the social networking platform whose personal profile is associated with that of the primary user. In simple terms, a secondary user comprises a “friend”, “connection”, or a “follower” of the primary user on the social networking platform. For example, the second user comprises a “friend”, if the social networking platform comprises Facebook™. In another example, the secondary user comprises a “connection” if the social networking platform comprises LinkedIn™.

The term “sharing” as used herein involves posting the aforementioned sharable information in a predefined format to the secondary users on their social networking platform, such as, Facebook™, Twitter™, Instagram™, LinkedIn™, etc. The term “primary user” includes, for example, a person that owns a remote user terminal providing access to the host system and to the social networking platform; a person that operates or utilizes a remote user terminal providing access to the host system and to the social networking platform; or a person that is otherwise associated with a remote user terminal providing access to the host system and to the social networking platform. A remote user terminal comprises a computing device including a wireless computing device, such as, a smartphone, a tablet computer, a laptop computer, etc.

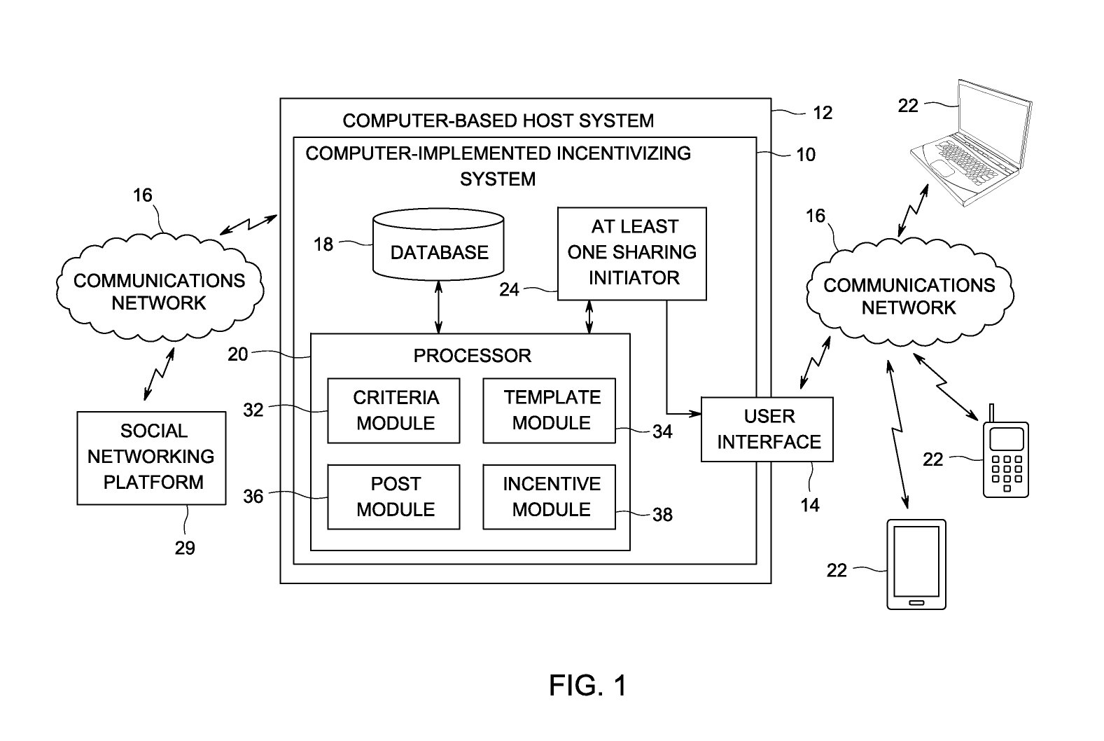

Referring to FIG. 1, the computer-implemented incentivizing system 10 of the present invention is designed to reside within and be used in conjunction with the aforementioned computer-based host system 12 as an auxiliary (or an add-on) module. The host system 12, as mentioned earlier, although may comprise any online entity, preferably comprises an online store that sells products, services, or both. The incentivizing system 10 comprises a user interface 14 for enabling the primary user to interact therewith over a communications network 16, such as, the Internet. The incentivizing system 10 further comprises a database 18 and a processor 20, the utility of each of which (in the context of the present invention) will become apparent from the following body of text.

Referring to FIG. 1, as mentioned earlier, as the incentivizing system 10 is a part of the host system 12, the user interface 14 of the incentivizing system 10 is same as that of the host system 12. In other words, the user interface 14 of the incentivizing system 10 is seamlessly integrated or unified with that of the host system 12, which, as mentioned earlier, may comprise a website, a computer application, or the like, depending on the remote user terminal 22 from which the host system 12 is accessed. The user interface 14 may be facilitated by remote user terminals 22, which may comprise desktop computers, laptop computers, notebook computers, tablet computers, mobile phones, cellular phones, PDAs, etc., capable of transacting data over the communications network 16. If the remote user terminal 22 employed by the primary user for accessing the incentivizing system 10 comprises a desktop PC, then the host system 12 is accessed via a website. On the other hand, if the remote user terminal 22 comprises a smartphone, then the host system 12 comprises a mobile computer application.

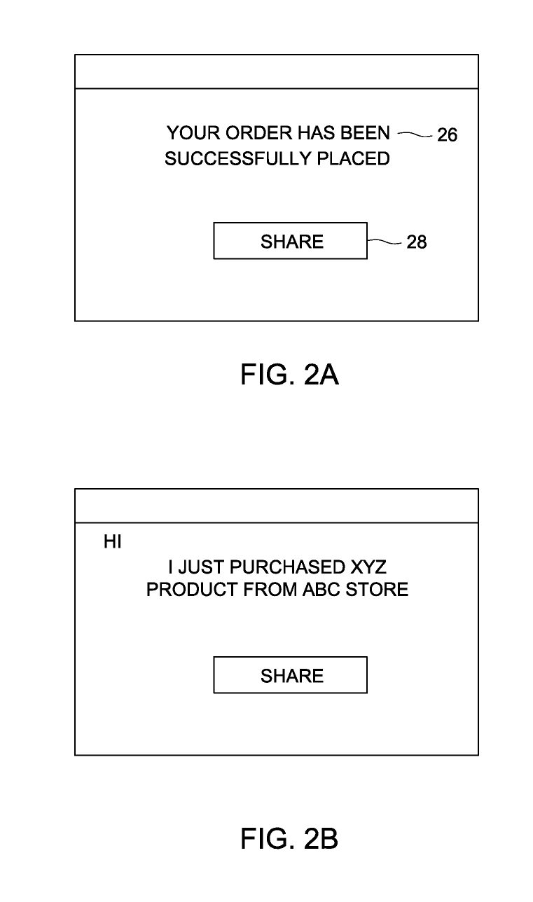

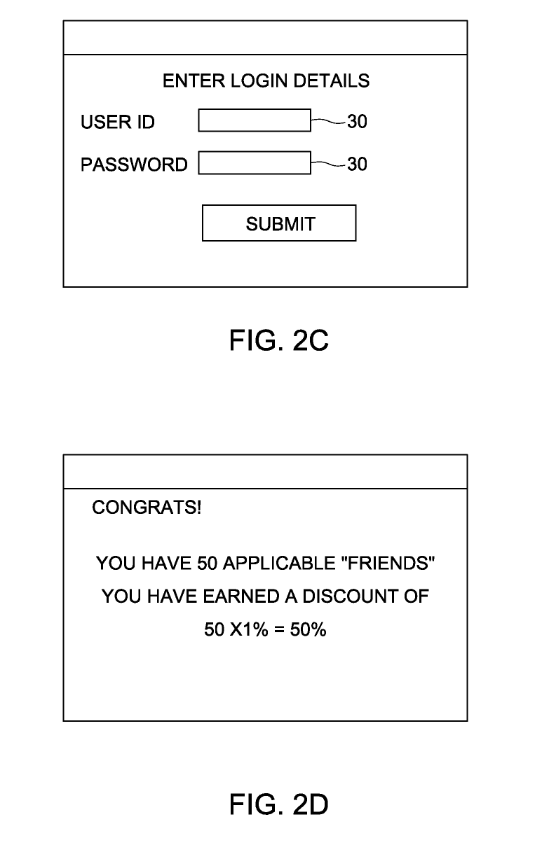

Referring to FIGS. 1, and 2A and 2B, the incentivizing system 10 further comprises at least one sharing initiator 24, each of which operatively coupled with the processor 20 and deployable by the primary user via the user interface 14. Each of the at least one sharing initiator 24 comprises a computer-based sharing hyperlink, or the like, accessible via the user interface 14. Each of the at least one sharing initiator 24 is associated with a sharable information on the host system 12. The exemplary screenshot in FIG. 2A depicts a sharable information 26 and the sharing hyperlink 28. The user interface further comprises access means comprising login fields 30 for inputting login details of the primary user for the social networking platform 29. The exemplary screenshot in FIG. 2B depicts login fields 30, which comprise an input field for receiving the user ID and another for receiving the password for the social networking platform. The primary user is prompted to enter the login details upon the deployment of a sharing initiator.

Referring to FIG. 1, the processor 16, for ease of understanding, is further divided into a plurality of processing modules comprising a criteria module 32, a template module 34, a post module 36 and an incentive module 38, the utility of each of which will become apparent from the following body of text.

Referring to FIG. 1, the criteria module 32 is configured such that, upon the input of the login details within the login fields, the criteria module 32, on behalf of the primary user, enters the social networking platform 29 and parses the primary user's personal profile so as to determine the applicable users according to the predefined criteria set by the host system 12. For example, the predefined criteria for an applicable user could be the secondary user that belongs from a particular geographical area, or that belongs to a particular age group, or even a combination of such factors. Notably, these factors are ascertained by the criteria module 32 from parsing of the personal profiles of the secondary users.

Referring to FIG. 1, the database 18 comprises a plurality of predefined templates listed therein wherein, each template is designed for a type of sharable information. For instance, if the sharable information comprises a purchase activity performed by the primary user (as seen in FIG. 2A), then the template predefined for such an activity is retrieved from the database 18 by the template module 34. The retrieved template, as enabled by the template module 34, is adapted to receive therewithin the product or service that is purchased, the name of the primary user (as defined in his/her social networking platform 29) so as to, as a result, construct a suitable sentence for sharing with the applicable users as seen in FIG. 2C, where “XYZ” is the product and “ABC” is the name of the store. For example, if a primary user named “Doug” purchased a pair of Florsheim™ shoes on Amazon™ (the host system), the “pair of Florsheim™ shoes” and the name of the primary user “Doug” is received by the template module 34 and an exemplary sentence “Doug purchased a pair of Florsheim™ shoes on Amazon™ today” is framed to be shared with the applicable users subsequently on the social networking platform 29. In one embodiment, additional comments may be added by the primary user along with the template information.

Referring to FIG. 1, the post module 36 receives the templated sharable information from the template module 34 (as seen in FIG. 2C)and disseminates or posts the same to the applicable users on behalf of the primary user. Simultaneously, the incentive module 38, according to the number of applicable users, determines the magnitude of the incentive that is to be awarded to the primary user. The incentive, as mentioned earlier, may comprise a shopping discount, a cashback, a freebie, or any other reward that is ‘proportionate’ to the number of applicable users determined by the criteria module 32. In one embodiment, the templated information is posted to all secondary users, but incentive that is generated is only proportionate to the number of applicable users. From the exemplary screenshot shown in FIG. 2D, it can be inferred that the criteria module 32 has identified 50 “applicable friends” and the incentive module 38 has determined the discount to be one percentage per applicable friend thereby, the total discount being 50%.

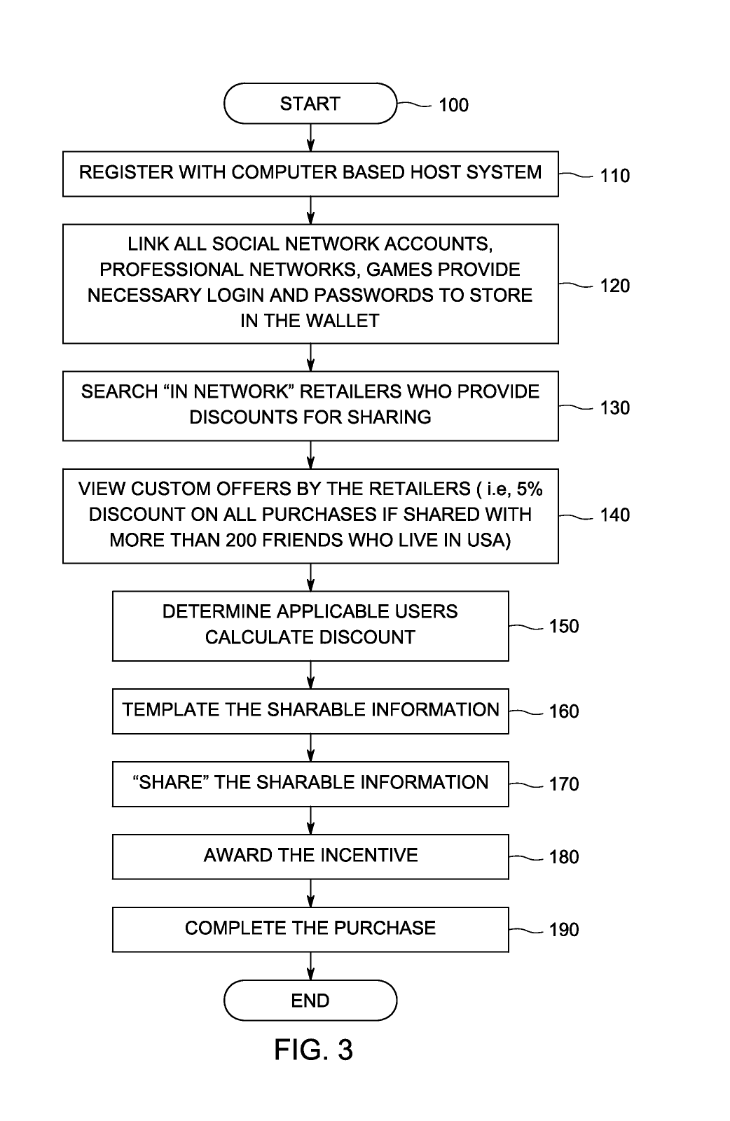

Referring to FIG. 3, the computer-implemented incentivizing method of the present invention initiates in step 100. The primary user registers with a computer-based host system in step 110. Next, the primary user links all social network accounts, professional networks, games and provides necessary login and password's to store in the wallet in step 120, and next, the primary user searches the ‘In Network’ retailers who provide discounts for sharing in step 130. The primary user views the custom offers by the retailers (for example 5% discount on all purchases if shared with more than 200 friends who live in the USA) in step 140. The applicable secondary users are determined that satisfy the predetermined condition by the criteria module, and the discount is calculated in step 150. The shareable information is templated in step 160, and in step 170, the shareable information is ‘Shared’. In step 180, the incentive is awarded in proportion to the number of applicable users to the primary user, and the purchase is complete in step 190.

Users will get a discount for sharing information, and might get additional award points if any of the friends end up shopping in that store.

Discussions herein utilizing terms such as, for example, “processing,” “computing,” “calculating,” “determining,” “establishing,” “analyzing,” “checking,” or the like, is able to refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that is able to store instructions to perform operations and/or processes.

The aforementioned embodiments are able to take the form of an entirely hardware embodiment, an entirely software embodiment, or an embodiment including both hardware and software elements. The embodiments are able to be implemented in software, which includes but is not limited to firmware, resident software, microcode, or the like.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A computer-implemented incentivizing system for providing a shopping incentive to a primary user in exchange for sharing sharable information on a computer-based host system with one or more secondary users on a social networking platform where the primary user holds a membership account, a secondary user comprising a fellow user of the primary user on the social networking platform the personal profile of whom is associated with that of the primary user, the magnitude of the shopping incentive provided to the primary user being proportionate to the number of applicable users the sharable information is shared with, an applicable user comprising a secondary user that satisfies a predefined condition, the discount system comprising:
(a) a user interface comprising:
(i) at least one sharing initiator, each of which associated with sharable information on the host system; and
(ii) access means for, upon the deployment of the at least one sharing initiator, receiving the login details of the primary user for the social networking platform;
(b) a criteria module for determining the number of applicable users associated with the primary user on the social networking platform;
(c) a post module for disseminating the sharable information to at least the applicable users; and
(d) an incentive module for generating the shopping incentive for the primary user based on number of applicable users determined by the criteria module.

2. The incentivizing system of claim 1 wherein, the shopping incentive comprises a discount.

3. The incentivizing system of claim 1 wherein, the post module disseminates the sharable information to all the secondary users.

4. The incentivizing system of claim 1 wherein, the sharable information comprises information displayed on the host system.

5. The incentivizing system of claim 1 wherein, the sharable information comprises information reflecting an activity performed by the primary user on the host system.

6. The incentivizing system of claim 5 wherein, the activity comprises a purchase activity performed by the primary user.

7. The incentivizing system of claim 1 wherein, each of the at least one sharing initiator comprises a sharing hyperlink.

8. The incentivizing system of claim 1 wherein, the sharable information is shared by the post module in a predefined format.

9. The incentivizing system of claim 8 further comprising a template module disposed in operative communication with each of the at least one sharing initiator, the template module for, upon the deployment of a sharing initiator, inserting the corresponding sharable information into a predefined template before being disseminated by the post module; the templated sharable information defining the predefined format of the sharable information.

10. The incentivizing system of claim 1 wherein, the access means comprises login data input fields.

11. A computer-implemented incentivizing system for providing a shopping incentive to a primary user in exchange for sharing sharable information on a computer-based host system with one or more secondary users on a social networking platform where the primary user holds a membership account, a secondary user comprising a fellow user of the primary user on the social networking platform the personal profile of whom is associated with that of the primary user, the magnitude of the shopping incentive provided to the primary user being proportionate to the number of applicable users the sharable information is shared with, an applicable user comprising a secondary user that satisfies a predefined condition set by the host system, the incentivizing system comprising:
(a) a user interface comprising:
(i) at least one sharing initiator, each of which associated with sharable information on the host system; and
(ii) login fields for, upon the deployment of the at least one sharing initiator, receiving the login details of the primary user for the social networking platform;
(b) a criteria module for determining the number of applicable users associated with the primary user on the social networking platform;
(c) a post module for disseminating the sharable information to at least the applicable users; and
(d) an incentive module for generating the shopping incentive for the primary user based on number of applicable users determined by the criteria module.

12. A computer-implemented incentivizing method for providing a shopping incentive to a primary user in exchange for sharing sharable information on a computer-based host system with one or more secondary users on a social networking platform where the primary user holds a membership account, a secondary user comprising a fellow user of the primary user on the social networking platform the personal profile of whom is associated with that of the primary user, the magnitude of the shopping incentive provided to the primary user being proportionate to the number of applicable users the sharable information is shared with, an applicable user comprising a secondary user that satisfies a predefined condition, the incentivizing method comprising:
(a) associating a sharing initiator with sharable information on the host system;
(b) upon the deployment of the sharing initiator, receiving, via a user interface, the login details of the primary user for the social networking platform;
(c) determining the number of applicable users associated with the primary user on the social networking platform;
(d) disseminating the sharable information to at least the applicable users; and
(e) generating the shopping incentive for the primary user based on number of applicable users that are determined.

13. The incentivizing method of claim 11 wherein, the shopping incentive comprises a discount.

14. The incentivizing method of claim 11 wherein, the sharable information is disseminated to all the secondary users.

15. The incentivizing method of claim 11 wherein, the sharable information comprises information displayed on the host system.

16. The incentivizing method of claim 11 wherein, the sharable information comprises information reflecting an activity performed by the primary user on the host system.

17. The incentivizing method of claim 15 wherein, the sharable information reflects a purchase activity performed by the primary user.

18. The incentivizing method of claim 11 wherein, the sharing initiator comprises a sharing hyperlink.

19. The incentivizing method of claim 11 wherein, the sharable information is shared in a predefined format.

20. The incentivizing method of claim 18 further comprising, upon the deployment of the sharing initiator, templating the sharable information before being disseminated; the templated sharable information defining the predefined format of the sharable information.

21. A computer-implemented incentivizing method for providing a shopping incentive to a primary user in exchange for sharing sharable information on a computer-based host system with one or more secondary users on a social networking platform where the primary user holds a membership account, a secondary user comprising a fellow user of the primary user on the social networking platform the personal profile of whom is associated with that of the primary user, the magnitude of the shopping incentive provided to the primary user being proportionate to the number of applicable users the sharable information is shared with, an applicable user comprising a secondary user that satisfies a predefined condition set by the host system, the incentivizing method comprising:
(a) associating a sharing initiator with the sharable information on the host system;
(b) upon the deployment of the sharing initiator, via a user interface, receiving the login details of the primary user for the social networking platform;
(c) determining the number of applicable users associated with the primary user on the social networking platform;
(d) disseminating the sharable information to at least the applicable users; and
(e) generating the shopping incentive for the primary user based on number of applicable users that are determined.
